(19) United States
(12) Patent Application Publication
(10) Pub. No.: US 2025/0278480 A1
(43) Pub. Date: Sep. 4, 2025

(54) Method for detecting an abnormality in an electronic system in operation

(71) Applicant: THALES, Meudon (FR)

(72) Inventors: Sylvain GIRBAL, PALAISEAU CEDEX (FR); Jimmy Alain Daniel LE RHUN, PALAISEAU CEDEX (FR); David José FAURA, PALAISEAU CEDEX (FR); Daniel GRACIA PÉREZ, PALAISEAU CEDEX (FR)

(21) Appl. No.: 18/725,109

(22) PCT Filed: Dec. 30, 2022
(86) PCT No.: PCT/EP2022/088064

§ 371 Date: Jan. 15, 2025

(30) Foreign Application Priority Data
Dec. 31, 2021 (FR) 2114743

(51) Int. Cl. G06F 21/55

(52) U.S. Cl. CPC G06F 21/554; G06F 21/552

(57) ABSTRACT

A method for detecting an anomaly in an electronic system in operation, in particular a cyberattack, the electronic system including processors that are each composed of hardware blocks, the processor being capable of executing an application with the application interacting with the hardware blocks. The detection method includes at least measuring, when the electronic system is in operation, at least one parameter representative of the interactions of the application with one of the hardware blocks, comparing each measurement with an associated reference dataset to detect potential inconsistencies between the measurement and the reference dataset, the reference dataset being representative of the operation of the electronic system when no anomalies are present, and sending an alert according to an alert criterion relating to the one or more detected inconsistencies.

### CROSS-REFERENCE TO RELATED APPLICATIONS

This application claims benefit under 35 USC § 371 of PCT Application N. PCT/EP2022/088064 entitled METHOD FOR DETECTING AN ANOMALY IN AN ELECTRONIC SYSTEM IN OPERATION, filed on Dec. 30, 2022 by inventors Sylvain Girbal, Jimmy Alain Daniel Le Ruhn, David José Faura and Daniel Gracia Pérez. PCT Application No. PCT/EP2022/087842 claims priority of French Patent Application No. 21 14743, filed on Dec. 31, 2021.

### FIELD OF THE INVENTION

The present invention relates to a method for detecting an abnormality in an operating electronic system, in particular a cyberattack on the electronic system.

The invention applies more particularly to the field of critical on-board computers such as same present in avionics, space, rail, automobile, maritime, etc. medical or IIoT (Industrial Internet of Things), traditionally confronted with problems of operational safety, the role of which is to protect the systems and the users thereof from failures and breakdowns.

### BACKGROUND OF THE INVENTION

Many certification standards related to said industries such as the standard DO178C/DO254 for avionics, the standard IEC61508 for the industry sector, the standard EN5012x for the railway sector, the standard ECSSx for the space field, provide the necessary safety guarantees on the reliability and availability of such systems. However, systems are becoming more and more connected, which brings in new problems related to cyber security and to the resistance to malicious attacks.

For example, in the avionics field, it is planned that air traffic control, which has a better overview, can fly aircraft from the ground during the approach phases of airports, bringing in new issues of authentication, confidentiality and integrity.

IIoT uses the principles of the Internet of things (or “IoT”) to apply same to the industrial sector, sharing data sensors from different systems, and maximizing machine-to-machine communications with no human intervention. IIoT promotes constant communication between the different systems to increase operational efficiency but is faced with the need to make such communications secure and to ensure the security of each of the systems forming IIoT, so that IIoT cannot be used as a back door to enter the system maliciously.

The field of wearable computing and implanted medical systems, in addition to traditional security issues, also faces data privacy and integrity issues.

Furthermore, secure systems are traditionally updated as soon as a security breach is discovered and corrected. However, systems with a high level of operational reliability are rarely updated, as an update generally involves re-certifying the entire system, which can carry very heavy financial costs. Effectively securing critical embedded systems cannot only use ad-hoc defenses for each type of attack that requires updating but should also make possible a proactive detection of new malicious attacks.

Intrusion Detection Systems (IDS) are known in cybersecurity. Such systems are generally classified into two categories, namely NIDS (Network Intrusion Detection System) and HIDS (Host Intrusion Detection System). NIDS focus on analyzing network communications. It concerns capturing traffic at a particular point in a network and analyzing packets by comparing with a database of attack patterns. If a set of packets matches a known attack pattern, an alert is raised. HIDS focus on a computer, at the level of the operating system thereof. It concerns detecting abnormal behaviors, by monitoring processes in progress, memory allocations, logged-in users, etc. An alert is generated when one of the monitored quantities deviates from a predefined norm.

All of said systems focus on security issues either at the software level or at the communication level. However, the most recent attacks have begun to exploit hardware vulnerabilities in the processor, which are much more complex and expensive to correct.

For example, the Spectre attack exploits a hardware vulnerability of some implementations of branching prediction of microprocessors provided with speculative execution. Whereas at the functional level, a prediction error is canceled as soon as it is found, speculative execution may, however, as a side effect, permit arbitrary access to locations in the random-access memory, the data used by the code having been executed “in the event of” remaining stored in the cache.

The Meltdown attack also exploits a vulnerability related to speculation used for out-of-order execution of instructions in the processor, including caches and the TLB (Translation Lookaside Buffer). Unlike the Spectre attack, the Meltdown attack uses mechanisms that are more specific to the processor architecture and provides access to data without the corresponding access rights, and also makes privilege escalation possible.

The Rowhammer attack exploits an unexpected side effect of DRAM (Dynamic Random Access Memory) causing electrical charge leakage into adjacent memory cells, which allows the content stored in the neighbor memory cells thereof to be modified without having access rights.

Thereby, known detection methods have become insufficient in front of the new generation of cyberattacks.

There is thus a need for a method apt to better detect and to hedge against anomalies affecting the electronic system, more particularly cyberattacks.

### SUMMARY OF THE DESCRIPTION

To this end, a method is proposed for detecting an anomaly in an electronic system in operation, more particularly a cyberattack against the electronic system, the electronic system comprising at least one processor each composed of a plurality of hardware blocks, the processor being suitable for executing at least one application by interactions of the application with said hardware blocks, the detection method comprising at least the following steps:
measuring, during the operation of the electronic system, at least one parameter representative of the interactions of the application with one of the hardware blocks in order to obtain measurements of said representative parameter,
for each measurement, comparison of said measurement with an associated reference dataset to detect any inconsistencies between the measurement and the reference dataset, said reference dataset being representative of the operation of the electronic system when there are no anomalies, and
sending an alert according to an alert criterion relating to the detected inconsistency or inconsistencies.

According to other particular embodiments, the method comprises one or a plurality of the following features, taken individually or according to all technically possible combinations:
the detection method further comprises at least one step selected from the group consisting of:
   analysis of the nature of the hardware block associated with each inconsistency,
   analysis of the time frequency of the inconsistencies, and
   analysis of the deviation of each measurement associated with the inconsistencies in the reference dataset;
the detection method comprises a detection step, depending on each analysis of an anomaly, in particular a cyberattack or a hardware failure of one of the hardware blocks.
when at least one alert associated with one of the hardware blocks is issued, a new iteration of the steps of the detection method starting from the measurement step is implemented, all the hardware blocks for which a representative parameter measurement is made being, at each iteration, included in all the hardware blocks of the preceding iteration, all the hardware blocks being included in particular in all the hardware blocks associated with the alert(s).
each alert criterion depends on at least one condition on the representative parameters, the detection method comprising, when an alert associated with one of the hardware blocks is issued, a new iteration of the steps of the detection method starting from the measurement step, the alert criterion comprising, at each iteration, an increasing number of conditions.
each representative parameter associated with one of the hardware blocks is chosen from the group consisting of:
   the type of data processed by the hardware block;
   the type of instructions executed by the hardware block;
   the number of accesses to the hardware block;
   the number of computations executed and/or the computation time of the hardware block;
   the number of hardware block malfunctions, and
   the number of interactions on an internal processor interconnection network involving the hardware block, and
   the number of interactions with the exterior of the processor via the hardware block.
each hardware block is chosen from the group consisting of:
   one or a plurality of computation units,
   one or a plurality of branching prediction units,
   one or a plurality of internal memory registers of the processor,
   one or a plurality of cache memories,
   one or a plurality of random-access memories,
   one or a plurality of processing chains,
   one or a plurality of memory protection or address translation units,
   one or a plurality of buses or interconnection networks,
   one or a plurality of input-output units
   each parameter representative of the operation of one of the hardware blocks being chosen from the group consisting of:
   the number of data of the same type processed by the computation unit(s), the interconnection network(s) or the memory(ies),
   the number of instructions of the same type executed by the computation unit or units,
   the energy consumption of the computation unit(s),
   the temperature of the computation unit or units,
   the number of successes and/or prediction errors of the branching prediction unit,
   the number of accesses to memories,
   the number of successes and/or errors of the requests of the cache memory,
   the number of successes and/or errors of the requests of the memory protection unit,
   the execution time of an instruction in the processing chain,
   the number of exchanges of information via the internal interconnection network(s) to the processor,
   the number of exchanges of information via the interconnection network(s) obtained by a given source,
   the number of exchanges of information via the interconnection network(s) sent to a given destination, and
   the number of exchanges of information via the input-output unit.
the electronic system comprises a plurality of counting hardware blocks each configured to measure one of the representative parameters, the measurement step comprising the measurement of a plurality of representative parameters, in particular between four and six, e.g. the representative parameters measured by a part of the counting hardware blocks.
the detection method further comprises a step of:
   comparison of the or each inconsistency associated with the issued alert with a set of predetermined known anomalies, and
   categorization of the alert when the or each inconsistency corresponds to one of the known anomalies of said set of anomalies.
the electronic system is a calculator on-board a transport platform.
the detection method is implemented by a system selected from the group consisting of:
   a dedicated programmable logic circuit forming one of said hardware blocks of the processor;
   a software of an operating system of the electronic system configured to interact with a memory protected by a memory protection unit, and
   an application apt to be implemented by the electronic system by adding a driver controlling the hardware blocks.

A computer program product including a readable storage medium is proposed, on which is stored a computer program comprising program instructions, the computer program being loadable on a data processing unit and suitable for leading to the implementation of detection method such as described hereinabove when the computer program is implemented on the data processing unit.

The invention further relates to a readable information medium on which is stored a computer program product such as described hereinabove.

A computer on-board a transport platform configured to implement the detection method as defined hereinabove is also proposed, the electronic system being the on-board calculator.

The invention further relates to a transport platform comprising the calculator as defined hereinabove.

The invention further relates to a method of generating a reference set, the reference set being representative of the operation of an electronic system in operation with no anomalies, the electronic system comprising at least one processor each composed of a plurality of hardware blocks, the hardware blocks comprising execution hardware blocks and counting hardware blocks, the processor being apt to execute at least one application by interactions of the application with said execution hardware blocks, each counting hardware block being apt to measure an operating parameter representative of the interactions of the application with one of the execution hardware blocks to obtain measurements of said representative parameter,
the generation method comprising at least the following steps:
execution of the application on a test bench according to a plurality of predetermined input data, said input data being representative of the operational use in operation of the electronic system with no anomalies,
measurements by at least one of the counting hardware blocks of at least one operating parameter representative of the interactions of one of the execution hardware blocks during the execution step with the application, to obtain measurements,
processing the measurements of at least one operating parameter, to obtain processed data, and
generation of the reference set from the processed data.

According to other particular embodiments, the method comprises one or a plurality of the following features, taken individually or according to all technically possible combinations:
during the measurement step, the measurements obtained are measurements of a plurality of operating parameters, in particular of a number of operating parameters comprised between four and six, the set of measurements obtained being, for example, only the operating parameters measured by part of the counting hardware blocks.
At least one new iteration of the steps of the generation method is implemented, the measurement step of one iteration being implemented by at least one counting hardware block different from the at least one counting hardware block implementing the measurement step of another iteration.
each operating parameter representative of the interactions of one of the execution hardware blocks with the application is chosen from the group consisting of:
   the type of data processed by the hardware block in question,
   the type of instructions executed by the hardware block in question;
   the number of accesses to the hardware block in question,
   the number of calculations performed and/or the calculation time of the hardware block in question,
   the number of malfunctions of the hardware block in question,
   the number of interactions on an internal processor interconnection network involving the hardware block, and
   the number of interactions with the exterior of the processor by the hardware block in question.
each execution hardware block is chosen from the group consisting of:
   one or a plurality of computation units,
   one or a plurality of branching prediction units,
   one or a plurality of memory registers,
   one or a plurality of cache memories,
   one or a plurality of random-access memories,
   one or a plurality of processing lines,
   one or a plurality of memory protection or address translation units,
   one or a plurality of buses or interconnection networks, and
   one or a plurality of input-output units,
each parameter representative of the operation of one of the execution hardware blocks being chosen from the group consisting of:
   the number of data of the same type processed by the computation unit(s), the interconnection network(s) or the memory(ies),
   the number of instructions of the same type executed by the computation unit,
   the energy consumption of the computation unit(s),
   the temperature of the computation unit or units,
   the number of successes and/or prediction errors of the branching prediction unit,
   the number of accesses to memories,
   the number of successes and/or errors of the requests of the cache memory,
   the number of successes and/or errors of the requests of the memory protection unit,
   the execution time of an instruction in the processing chain,
   the number of exchanges of information on the internal interconnection network(s) of the processor,
   the number of exchanges of information via the interconnection network(s) per source,
   the number of exchanges of information via the interconnection network(s) per destination, and
   the number of exchanges of information via the input-output unit.
the execution of the application is implemented in at least two successive time phases, the processing step being implemented by applying respective operations on the measurements of each phase
the application is configured to implement at least two functions, each function being implemented during a specific time phase.
each time phase corresponds to a predetermined time interval of application execution, including a time interval of less than 300 milliseconds.
the processing step comprises an aggregation of the measurements for each operating parameter, for obtaining a database specific to each operating parameter.
the set of measurements and the set of processed data occupy a respective size in a memory, the processing step comprising the application of an operation whereby the size of the set of processed data is smaller than the size of the set of measurements.
the operation is implemented by a machine learning technique comprising training based on the set of measurements.
the machine learning technique comprises the training of a neural network based on the set of measurements.
the operation is a statistical analysis operation such that the set of processed data is a statistical distribution of the set of measurements.
a predetermined number of iterations of the measurement step is implemented to obtain a first set of measurements and a first set of processed data, the generation method further comprising the following steps:
   second implementation of the predetermined number of iterations of the measurement step, for obtaining a second set of measurements and a second set of processed data,
   comparison of the first processed dataset and of the second processed dataset according to a predetermined convergence criterion,
   when the convergence criterion is not met, implementation of a number of iterations of the measurement step greater than the predetermined number of iterations, and
   when the convergence criterion is met, generation of the reference set from the first and second processed datasets.

The invention further relates to a reference set which can be obtained by a generation method such as defined hereinabove.

The invention further relates to the use of the reference set as defined hereinabove to detect an anomaly in the electronic system in operation, more particularly a cyberattack against the electronic system, by comparing at least one measurement of at least one of the operating parameters during the operation of the electronic system and by comparing that measurement with the reference set to detect any inconsistencies between the measurement and the reference set.

The present description also relates to a computer program product including a readable storage medium, on which is stored a computer program comprising program instructions, the computer program being loadable on a data processing unit and suitable for leading to the implementation of generation method such as defined hereinabove when the computer program is implemented on the data processing unit.

The invention further relates to a readable storage medium on which is stored a computer program comprising program instructions, the computer program being loadable on a data processing unit and suitable for leading to the implementation of a generation method such as defined hereinabove when the computer program is implemented on the data processing unit.

### BRIEF DESCRIPTION OF THE DRAWINGS

The invention will be better understood upon reading the following description, given only as an example, but not limited to, and making reference to the enclosed drawings wherein:

FIG. 1 is a schematic representation of an electronic system according to the invention on-board a transport system,

FIG. 2 is a flowchart of the generation method according to the invention, for generating a reference set,

FIG. 3 is a flowchart of the slicing steps of the generation method,

FIG. 4 is a flowchart of the measurements and processing steps of the generation method,

FIG. 5 is a flowchart of a detection method according to the invention, for detecting an anomaly,

FIG. 6 is a schematic representation of processor on-board the electronic system shown in FIG. 1.

### DETAILED DESCRIPTION OF EMBODIMENTS

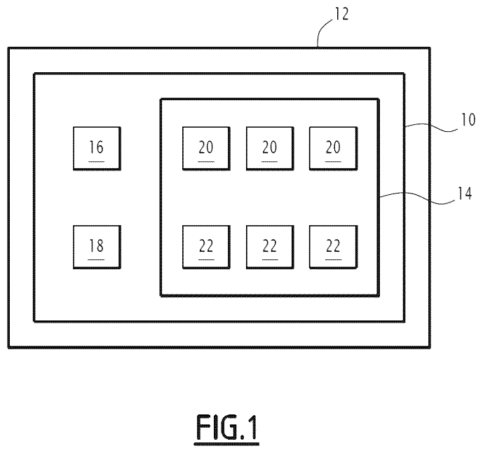

FIG. 1 shows an electronic system 10.

The electronic system 10 is embedded in a transport platform 12. The transport platform 12 is in particular suitable for transporting passengers and/or goods.

The transport platform 12 is, more particularly, an avionics transport platform such as an airplane, a helicopter or a drone.

In a variant, the transport platform 12 is a space transport platform such as, e.g., a satellite or a space shuttle; a rail transport platform, in particular a train; a maritime transport platform such as a ship or a submarine or an automobile transport platform such as e.g. an autonomous car or bus.

In another variant, the invention applies to any field wherein critical on-board calculators are present. In particular, in a variant, the electronic system 10 is embedded in a medical device, in a portable computer, in a home automation system or in an industrial system.

If appropriate, the platform 12 comprises a plurality of electronic systems 10. For example, when the transport platform 12 is an aircraft, the platform comprises a take-off system, a pilot system, a communication system, a warning system, etc.

As can be seen in FIG. 1, the electronic system 10 comprises at least one processor 14, an operating system 16 and a memory 18.

The operating system 16 (often referred to as OS) is a set of programs which directs the use of the resources of the electronic system 10 through applications.

Each processor 14 is composed of a plurality of hardware blocks.

The hardware blocks comprise execution hardware blocks 20 and counting hardware blocks 22.

An execution hardware block 20 is an electronic component configured to execute an elementary function of the processor 14 such as computation, memory storage or data transfer.

More particularly, the processor 14 is suitable for executing at least one application by interactions of the application with the execution hardware blocks 20.

The application is a program suitable for performing a task, or a set of elementary tasks. The application runs using the operating system services to use the hardware resources provided by the execution hardware blocks 20.

More particularly, each execution hardware block 20 is chosen from the group consisting of:
one or a plurality of computation units,
one or a plurality of branching prediction units,
one or a plurality of internal memory registers of the processor 14,
one or a plurality of cache memories,
one or a plurality of random-access memories,
one or a plurality of processing lines,
one or a plurality of memory protection or address translation units,
one or a plurality of buses or interconnection networks, and
one or a plurality of input-output devices.

The different execution hardware blocks 20 make it possible to provide the hardware resources needed for the execution of the different applications.

Each counting hardware block 22 is suitable for measuring an operating parameter representative of the interactions of the application with one of the execution hardware blocks 20 with the application, in order to obtain measurements of said representative parameter.

Advantageously, the electronic system 10 comprises a plurality of counting hardware blocks 22 each suitable for measuring a specific operating parameter.

The electronic system 10 comprises in particular between four and six counting hardware blocks 22.

In a variant, the electronic system 10 comprises more than six counting hardware blocks 22.

Each representative parameter associated with one of the execution hardware blocks 20 is chosen from the group consisting of:
the type of data processed by the execution hardware block 20;
the type of instructions executed by the execution hardware block 20;
the number of accesses to the execution hardware block 20;
the number of computations executed and/or the computation time of the execution hardware block 20;
the number of malfunctions of the execution hardware block 20, and
the number of interactions on an interconnect network internal to the processor involving the execution hardware block 20, and
the number of interactions with the exterior of the processor 14 through the execution hardware block 20.

Examples of data types include a Boolean type, an integer type, a floating-point real type, a character type, etc.

The different instructions are e.g. a calculation instruction, a data sending instruction, a storage instruction, etc.

Each internal interconnection network of the processor 14 forms a gateway allowing communication between different entities of the processor, in particular between the different hardware blocks.

More specifically, each parameter representative of the operation of one of the execution hardware blocks 20 is chosen from the group consisting of:
the number of data of the same type processed by the computation unit(s), the interconnection network(s) or the memory(ies),
The number of instructions of the same type executed by the computation unit or units,
the energy consumption of the computation unit or units,
the temperature of the computation unit or units,
the number of successes and/or prediction errors of the branching prediction unit,
the number of accesses to memories,
number of successes and/or errors of the requests of the cache memory,
number of successes and/or errors of the requests of the memory protection unit,
the execution time of an instruction in the processing chain,
the number of exchanges of information via the internal interconnection network(s) to the processor 14,
the number of exchanges of information via the internal interconnection network(s) obtained by a given source,
the number of exchanges of information via the internal interconnection network(s) sent to a given destination, and
number of exchanges of information via the input-output unit.

The memory 18 stores a set of reference data, or also called hereinafter a reference set.

The reference dataset is representative of the operation with no anomalies, of the electronic system 10.

“Operation with no anomalies” means an operation of the electronic system 10 as planned and envisaged during the design and the use thereof. Abnormal operation is thus an operation that deviates from what was envisaged during the use of the electronic system 10, due e.g. to a cyberattack or to a hardware and/or software failure. More particularly, an anomaly-free operating margin is defined around the operating values provided during the design of the system. As an example, an operating temperature range with no anomalies of the computation units is determined at design. Abnormal operation is detected when the temperature is e.g. 10° C. warmer than the maximum limit of the interval of operation with no anomalies.

As explained thereafter, the reference dataset, or reference set, is used to detect possible inconsistencies between the measurement of an operating parameter and the all the reference data.

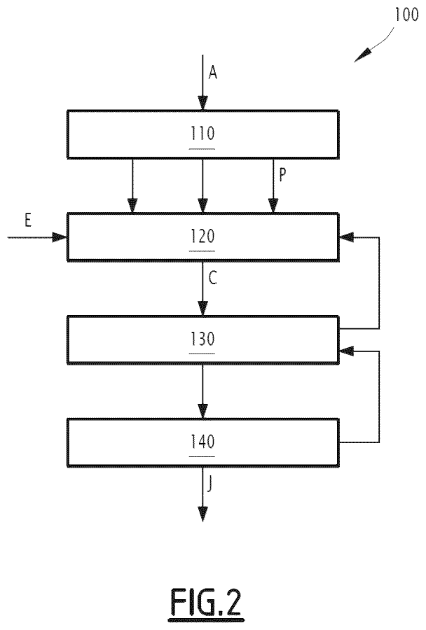

A method of generating 100 such a reference set will now be described, with reference to FIG. 2 representing a flowchart of said generation method 100.

The generation method 100 comprises an execution step 120 for executing the application A on a test bench according to a plurality of predetermined input data E.

A test bench means a test environment allowing the electronic system 10 to be put in controlled conditions of use, the parameters of which can be set in order to observe and measure the behavior of the system. The execution on a test bench is thus different from the subsequent operational use in operation of the electronic system 10.

The input data E are representative of the operational use with no anomalies of the electronic system 10.

The input data E are determined according to the intended use of the electronic system 10 in operation. Feedback from the operation of similar electronic systems is also used. The input data are chosen to cover a wide variety of events which can be encountered by the electronic system 10 during the use thereof in normal operation with no anomalies.

The application A is configured to implement at least two functions, each function being implemented during a specific time phase P.

As an example, the application A comprises an initial data acquisition phase, a data processing phase, a storage phase and a data sending phase.

Thereby, the execution of the application A is implemented according to at least two successive time phases P.

The generation method 100 thus comprises a prior step 110 of slicing the application A into phases P.

Indeed, as will be explained in more detail thereafter, an overall processing of an entire application the behavior of which would vary significantly during the execution of the application would risk to leading to the creation of a reference set that is not sufficiently selective, which would make it difficult to detect abnormal behavior.

Depending on the type of application, the slicing is a time slicing or a functional slicing.

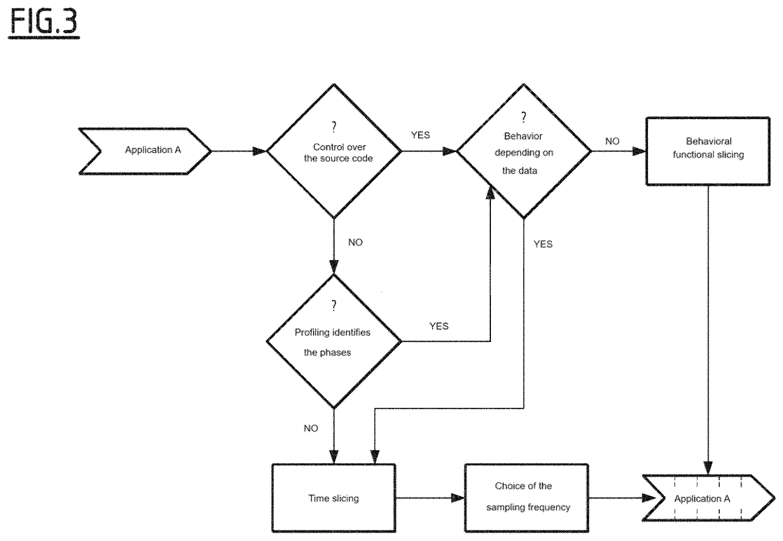

More particularly, FIG. 3 shows a decision tree for choosing the type of slicing of the application A.

Thereby, the time slicing is chosen when the source code of the application A is not known or mastered and the identification of the phases is not easy.

On the other hand, when the source code is controlled and the behavior of the application A is not dependent on the input data, it is possible to identify phases P of application A and functional slicing will be preferred.

Indeed, performing a functional slicing and an identification of the behavioral phases P of an application requires a certain control over of the application, which is not always the case when integrating third-party applications. In such a “black box” context, traditional profiling solutions (such as e.g. using the known software Gprof) or static code analysis can help identify the application phases, and make such a functional slicing possible. Such profiling searches in particular for regular loops, i.e. sets of instructions the conditionals and loop bounds of which can be expressed as affine functions of the encompassing iterators.

However, if the behavior of the application A is highly dependent on data, as may be the case for cryptographic applications, a behavioral functional slicing is not possible because it is not repeatable from one execution to another.

In such case, the slicing is a time slicing which requires an additional step of selecting the sampling frequency.

Such choice has an impact on the total number of phases P and is determined by seeking a compromise between the fineness of the characterization of the phases and the size of the reference set obtained.

For example, within the framework of periodic embedded applications, the slicing is performed on the basis of said period.

However, if the activation of a task is itself composed of phases such as a data recovery phase, a calculation phase and a result delivery phase, the sampling frequency is higher

More particularly, each time phase P corresponds to a predetermined time interval of execution of the application, in particular a time interval of less than 300 milliseconds, typically 200 milliseconds.

The generation method 100 comprises a step of measurements 130, by at least one of the counting hardware blocks 22, of at least one operating parameter representative of the interactions of one of the execution hardware blocks 20 during the execution step with the application, in order to obtain measurements. The measurements obtained are thus measurements of a plurality of operating parameters, as defined hereinabove.

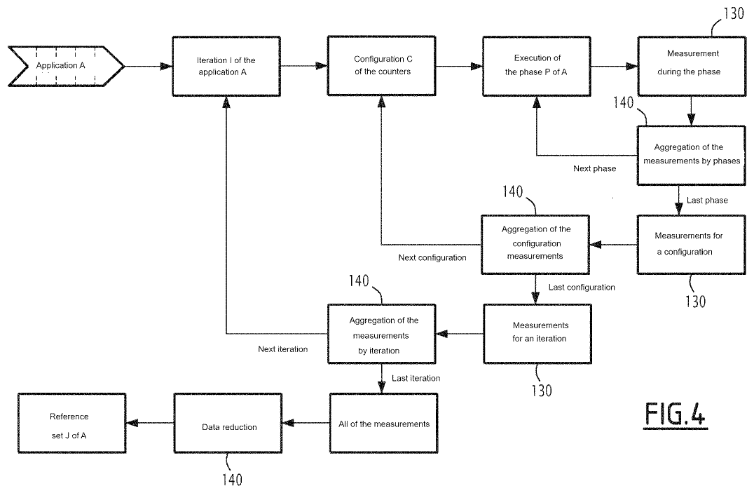

FIG. 4 illustrates in particular the measurement step 130.

The measurements are carried out phase-by-phase, in order to obtain a set of measurements of the operating parameters per phase.

At least one new iteration I of the steps of the generation method 100 is implemented, the measurement step 130 of one iteration being implemented by at least one counting hardware block 22 different from the at least one counting hardware block 22 implementing the measurement step of another iteration I.

A set of counting hardware blocks 22 measuring the operating parameters during an iteration I is called a configuration C of counting hardware blocks 22.

As explained hereinabove, it is not possible to determine a priori which hardware events will be targeted and thus involved in possible future cyberattacks and having only a reduced number of counting hardware blocks 22 compared with the large number of events, it is thus advantageous to go through all the hardware events equally and to vary the configurations of the counting hardware blocks 22.

In order to collect statistically significant data, the application A is executed over a large number of iterations I, with different input data, to capture distributions of possible values of the different operating parameters in nominal operation.

The generation method 100 then comprises a processing step 140 for processing measurements of the operating parameters, in order to obtain processed data.

More particularly, the processing step 140 is implemented by applying respective operations to the measurements of each phase.

The processing step 140 comprises in particular an aggregation of the measurements for each operating parameter in order to obtain a database specific to each operating parameter.

More particularly, the processing 140 comprises an aggregation of measurements per phase P, measurements per configuration C, and measurements per iteration I in order to obtain a set of collected statistical data. At the end of each of such steps, the collected values are aggregated as follows.

During a phase, all the pairs (event, value) are collected such that the event belongs to the current configuration of counting hardware blocks 22.

The aggregation per phase P consists in grouping all the measured values in a table indexed by phase.

The aggregation per configuration C extends the set of events beyond the current configuration to cover the set of configurations needed for covering all hardware events envisaged during normal operation.

The aggregation per iteration I differs from the preceding aggregation by replacing the pairs (event, value) by pairs (event, set of all the values observed during the different iterations).

The set of all of the measurements collected for the application A may thereby be very large and typically represent several gigabytes of collected data.

It is then useful to reduce the data in order to obtain a reference set J of reduced size, which can be integrated into the memory 18 of the electronic system 10.

The processing step 140 then comprises the application of an operation enabling the memory size of the set of processed data to be smaller than the memory size of the set of all of the measurements.

More particularly, the operation is implemented by a machine learning technique comprising a training based on the set of measurements.

The machine learning technique is implemented in particular by training a neural network from the set of all measurements. The reference set, once trained, would then become said network. Symbolic learning or segmentation techniques are used in a variant.

In a variant, the reduction operation is a statistical analysis operation such that the set of processed data is a statistical distribution of the set of all measurements.

Such operation is similar to that operation currently performed to view the statistical data using e.g. histograms or plot boxes.

The statistical distribution comprises a plurality of values giving key information about the statistical distribution such as the minimum, the maximum, the mean, the median, the standard deviation, deciles, quartiles, etc. For example, such values are the different bins of a histogram or quartiles for the plot boxes.

Said plurality of values then becomes the reference set J.

It is thus necessary to reduce the size of the data collected but it is also important to make sure that the data collected are statistically representative of the application. It is thus necessary to assess the statistical coverage of the collected data.

Thereby, a predetermined number of iterations of the measurement step 130 is implemented in order to obtain a first set of measurements and a first set of processed data.

The generation method 100 then further comprises a second implementation of the predetermined number of iterations of the measurement step 130 to obtain a second set of measurements and a second set of processed data.

Then, the first processed dataset is compared with the second processed dataset according to a predetermined convergence criterion.

The convergence criterion determines whether the two distributions are statistically similar. The literature proposes different solutions to said problem such as e.g. the comparison of histograms by calculating the Bhattacharyya distance, the Kullback-Leiber divergence or the Hellinger distance.

When the convergence criterion is not met, the generation method 100 comprises the implementation of a number of iterations of the measurement step 130 greater than the predetermined number of iterations.

In other words, the two statistical distributions collected are concatenated and the collection of a larger distribution, e.g. a double size, is reiterated.

Said step is reiterated until a convergence of the statistical distribution is obtained. When the convergence criterion is met, the generation method 100 comprises the generation of the reference set J from the first and second sets of processed data.

A reference set J is thus obtained from the processed data. As will be explained thereafter, the reference set is used in particular to detect an anomaly in the electronic system 10 in operation, more particularly a cyberattack against the electronic system 10, by comparing at least one measurement of at least one of the operating parameters during the operation of the electronic system 10 and by comparing that measurement with the reference set, to detect any inconsistency between the measurement and the reference set.

However, other applications of the reference set J thereby generated, are possible.

Indeed, in critical fields such as automotive, rail, avionics or space, the current trend of on-board electronic/computer systems is to move toward the use of generic computing platforms ensuring both functionality and safe operation and safety properties.

Such computing platforms have a limited set of hardware resources and have run one or a plurality of application software, of different criticality levels and coming from different vendors.

The complexity of the new embedded systems for the critical fields and the sharing of the market between the different economic actors required the modification of the industrial process by redefining the roles and responsibilities between the different parties involved when designing a system. Each of the players is responsible for providing the technological bricks assigned to them and for applying the requirements imposed on them by the operating requirements of the system.

The hardware platform provider must deliver the calculator and all the electronic equipment needed for the proper functioning of the software applications that may be assigned to the provider.

The provider of the operating system provides the operating system for the management of the execution of the different application software according to the needs thereof in terms of priority, of execution time and of frequency, of memory space, etc.

The provider of application software is responsible for the proper functioning of the applications thereof while complying with the instructions provided by the system integrator regarding the rules for the use of the hardware resources of the system.

Finally, the system integrator is entrusted with the central role. The system integrator assembles the different technological bricks, both hardware and software of the system while allocating all the necessary resources to the provider of software applications. In addition, the system integrator is responsible for consolidating the operating requirements and taking into account the interactions of the different technological bricks with the resources of the system. The system integrator is the one that has to guarantee the security of operation and the overall security of the system.

The control over the system involves all participants, each at their level of responsibility, but it is the responsibility of the system integrator to define and validate the entire system under construction by ensuring that the applications running on the computation platforms of the system meet at all times non-functional specifications, such as time, energy and resource sharing required for computation, safety, security, etc.

In such context, the reference set J is advantageously used to transmit the requirements of the system integrator to the other actors and to transmit the non-functional properties of the applications to the integrator as the actual need in terms of shared hardware resources.

Indeed, by providing the corresponding reference set with along with the application thereof, the software provider provides information related to the use of hardware resources by the application thereof, and hence a rate of use of the different shared resources.

The reference set J is also a way for the system integrator to translate the requirements into a maximum resource utilization envelope for each application, so as to ensure the coexistence of the requirements in the final integrated system.

The reference set J representing the hardware behavior of the applications thus has a plurality of fields of applicability.

The reference set J can be used in a cyber-security context, as will be explained thereafter, to hedge against external cyber-attacks.

Within the frame of dependability, the reference set J can also be used to participate in the monitoring of the system, to detect abnormal cases related to failures and initiate the measures aimed at a return to a stable state.

The reference set J can also be used as a means of transmitting non-functional requirements. Indeed, within the framework of multi-core processors, which are as such complex systems from third-party suppliers and usually have partial specifications, the usual technique of temporal partitioning having become insufficient.

The reference set J can also be used to facilitate the integration of applications by taking into account the specific use thereof of shared hardware resources. The usual technique based on abstract models is no longer suitable for multi-cores.

The reference set J can also be used to build a library of representative applications of a field by characterizing same via the distance between the respective reference sets thereof.

In an incremental certification framework, the reference set J can also be used to anticipate the impact of integrating a new application into the system, knowing the reference set thereof.

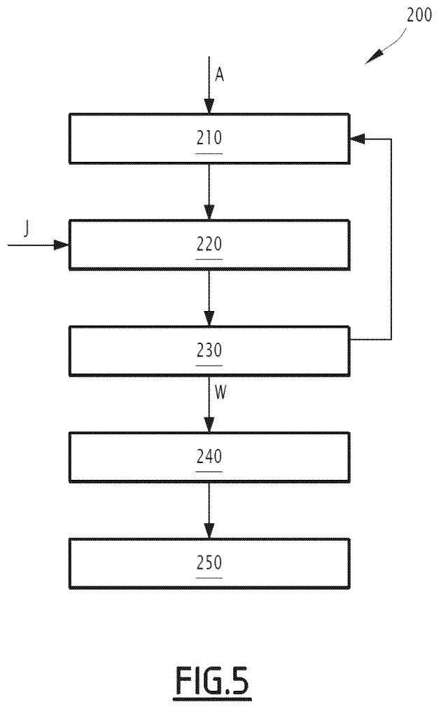

A method 200 for detecting an anomaly in an electronic system 10 in operation will now be described with reference to FIG. 5 representing a flowchart of said detection program 200.

The detection method 200 is carried out using a reference set as generated hereinabove.

More particularly, the method 200 aims to detect a cyberattack against the electronic system 10.

However, the detection method 200 is also suitable for detecting a hardware and/or software failure of the electronic system 10.

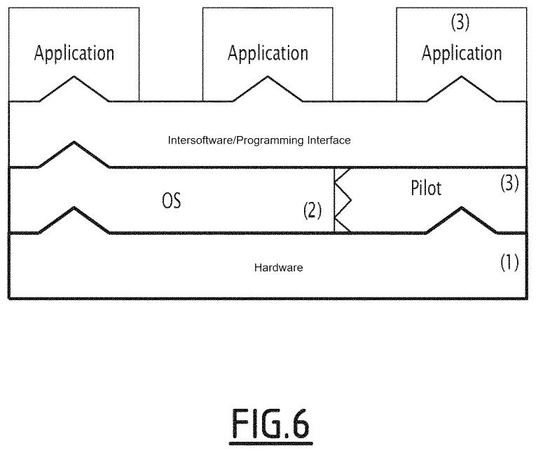

A plurality of embodiments are possible for implementing the detection method, as illustrated in FIG. 6.

According to a first embodiment, the detection method is implemented by a dedicated programmable logic circuit forming one of said hardware execution blocks 20 of the processor 14.

Thereby, such implementation is carried out at the hardware in the form of a dedicated component, as shown schematically in FIG. 6 with the number reference 1. This component could thereby reprogram and operate the counting hardware blocks 22 without worrying about the privilege levels required at the software level. A hardware component also makes it easy to have dedicated memory for storing reference sets within the component as such.

Such embodiment therefore provides a highly secure solution.

According to a second embodiment, the detection method is implemented by a software of an operating system 16 of the electronic system 10 configured to interact with a memory protected by a memory protection unit.

Such embodiment is shown diagrammatically in FIG. 6 with the reference number 2.

In such case, the reference set is stored in the main memory. The software will benefit from the high privilege levels of the operating system to configure and read the counting hardware blocks 22. The storage zone of the reference sets is protected via the memory management unit (MMU).

According to a third embodiment, the detection method is implemented by an application suitable for being implemented by the electronic system 10 by adding a pilot controlling the hardware blocks, as represented schematically in FIG. 6 with the number reference 3.

Thereby, the method is implemented in the form of an application running at the same level as the applications to be monitored.

Such embodiment is the easiest to implement.

In another variant, the detection method is implemented via a hybrid implementation, both software and hardware, such as e.g. a software implementation that stores the reference sets in a dedicated hardware flash memory, to protect the memory space of the reference sets.

In the initial state of the detection method 200, the electronic system 10 is in operational operation.

For example, the electronic system 10 is carried on-board an aircraft which is flying to an airport. The electronic system 10 is then e.g. an avionics system for communication, piloting, etc.

The detection method 200 comprises a first measurement step 210 for measuring, during the operation of the electronic system 10, at least one parameter representative of the interactions of the application A with one of the execution hardware blocks 20 in order to obtain measurements of said representative parameter.

The representative parameters are as defined hereinabove. Same correspond more particularly to parameters for which measurements have been made during the method of generating the associated reference set.

For each measurement, the detection method 200 comprises the comparison 220 of the measurement with the associated reference dataset, to detect any inconsistencies between the measurement and the reference dataset.

An inconsistency is a statistical deviation of the measurement from the reference set. For example, the measurement is not comprised in the envelope formed by the reference set.

Any deviation indicates an abnormal behavior of the application that could be related to a cyberattack.

Thereby, the detection method 200 comprises a sending step 230 of sending an alert W according to an alert criterion relating to the detected inconsistency or inconsistencies.

Each alert criterion depends on at least one condition on the representative parameters. Each alert criterion is e.g. a threshold value of the measured parameter.

During the generation phase 100 of the reference set J, it is possible to build an exhaustive reference set, at the cost of many executions of the application, with a set of different events. On the other hand, during the detection phase 200, it is not possible to execute the application several times in order to detect an attack. The detection has to take place directly, during the execution.

Thereby, only a limited number of parameters is measured from counting hardware blocks 22 in order to minimize the detection time.

According to one embodiment, the measured parameters are rapidly alternated in order to cover all significant events in a short period of time, by sampling.

In a variant, the measured parameters are selected by hierarchical selection of the monitored events.

When at least one alert W associated with one of the execution hardware blocks 20 is sent, a new iteration of the steps of the detection method 200 is implemented starting from the measurement step 210.

The set of execution hardware blocks 20 for which a representative parameter measurement is made is, at each iteration, included in the set of execution hardware blocks 20 of the preceding iteration, the set of execution hardware blocks 20 being included in the set of execution hardware blocks 20 associated with the alert(s).

Thereby, a small number of events is chosen, corresponding to the number of counting hardware blocks 22 available and covering the different execution hardware blocks 20 of the processor 14, in order to form a first monitoring level.

If one or a plurality of such events are exceeded with respect to thresholds from the reference set, a suspicion of attack is lifted and the measured parameters are reconfigured to focus on the execution hardware block 20 concerned, in order to confirm or disprove the suspicion.

The measurement steps 210 are thereby advantageously repeated on a plurality of hierarchical levels. The present method makes it possible to improve the reliability of the detection despite the limited number of counting hardware blocks 22.

When an alert W associated with one of the execution hardware blocks 20 is sent, the detection method 200 comprises a new iteration of the steps of the detection method 200 starting from the measurement step 210, the alert criterion comprising, at each iteration, an increasing number of conditions.

Thereby, it is possible to refine the alert and more precisely characterize the suspicion of attack.

For example, a first alert condition is a memory access threshold of a hardware block being exceeded. At the next iteration, the alert condition comprises, in addition to the threshold, the exceeding of a threshold of computations executed by the hardware block.

The method 200 then comprises the analysis 240 of the nature of the execution hardware block 20 associated with each inconsistency, the analysis of the time frequency of the inconsistencies, and/or the analysis of the deviation from the reference dataset, of each measure associated with the inconsistencies.

The detection method 200 then comprises a detection step 250, depending on each analysis of an anomaly, more particularly a cyberattack or a hardware failure of one of the hardware blocks.

Indeed, depending on the frequency, the type and the severity of abnormal events, it is possible to distinguish a cyberattack from a hardware failure. More particularly, transient events linked to operational safety are essentially isolated and result in a peak at the counting hardware blocks 22.

Cyber-security events, on the other hand, last for the duration of the attack, and attacks generally have a more lasting effect on the counting hardware blocks 22.

By comparing the inconsistency associated with the sent alert with a set of predetermined known anomalies, the method comprises the categorization of the alert when the or each inconsistency corresponds to one of the known anomalies of said set of anomalies.

It is thereby possible to know the nature of the anomaly encountered, in particular the type of cyberattack, and to react accordingly.

However, the detection method 200 does not depend on the type of attack. The method further detects new classes of attacks targeting hardware or software.

Finally, as components age, the frequency of transient events gradually increases until a permanent failure. The detection method, via such analysis, makes it possible to observe such frequency variation, to participate in the preventive maintenance of the components and to prevent such type of failures.

1. A detection method for detecting an anomaly in an operating electronic system, the electronic system comprising at least one processor each composed of a plurality of hardware blocks, each processor executing at least one application by interactions of the at least one application with the hardware blocks, the detection method comprising:
measuring, during the operation of the electronic system, at least one parameter representative of the interactions of the application with one of the hardware blocks in order to measure the representative parameter;
for each measurement, comparing the measurement with an associated reference dataset to detect inconsistencies between the measurement and the reference dataset, the reference dataset being representative of the operation of the electronic system when there are no anomalies; and
sending an alert according to an alert criterion relating to the detected inconsistency or inconsistencies.

2. The detection method according to claim 1, further comprising:
at least one analyzing operation selected from the group consisting of:
analyzing the nature of the hardware block associated with each inconsistency,
analyzing the time frequency of the inconsistencies, and
analyzing the deviation of each measurement associated with the inconsistencies of the reference dataset; and
depending on each analysis, an anomaly.

3. The detection method according to claim claim 1, further comprising, when at least one alert associated with one of the hardware blocks is transmitted, implementing a new iteration of the detection method starting from said measuring, wherein the set of hardware blocks for which a representative parameter measurement is performed is, at each iteration, included in the set of hardware blocks of the preceding iteration.

4. The detection method according to claim 1, wherein each alert criterion depends on at least one condition on the representative parameters, the detection method further comprising, when an alert associated with one of the hardware blocks is transmitted, implementing a new iteration of the detection method starting from said measuring, the alert criterion comprising, at each iteration, an increasing number of conditions.

5. The detection method according to claim 1, wherein each representative parameter associated with one of the hardware blocks is chosen from the group consisting of:
the type of data processed by the hardware block,
the type of instructions executed by the hardware block,
the number of accesses to the hardware block,
number of computations executed and/or the computation time of the hardware block,
the number of malfunctions of the hardware block,
the number of interactions on an internal interconnection network to the processor involving the hardware block, and
the number of interactions with the exterior of the processor via the hardware block.

6. The detection method according to claim 1,
wherein each hardware block is chosen from the group consisting of:
one or more computation units,
one or more branching prediction units,
one or more internal processor memory registers,
one or more cache memories,
one or more random-access memories,
one or more processing chains,
one or more memory protection or address translation units,
one or more buses or interconnection networks, and
one or more input-output devices, and wherein each parameter representative of the operation of one of the hardware blocks is chosen from the respective group consisting of:
the number of data of the same type processed by the computation unit(s), the interconnection network(s) or the memory(ies),
the number of instructions of the same type executed by the computation unit or units,
the energy consumption of the computation unit or units,
the temperature of the computation unit or units,
the number of successes and/or prediction errors of the branching prediction unit or units,
the number of accesses to memory or memories,
the number of successes and/or errors of the requests of the cache memory or memories,
the number of successes and/or errors of the requests of the memory protection unit or units,
the execution time of an instruction in the processing chain or chains,
the number of exchanges of information via the internal interconnection network(s) to the processor,
the number of exchanges of information via the interconnection network(s) obtained by a given source,
the number of exchanges of information via the interconnection network(s) sent to a given destination, and
the number of exchanges of information via the input-output device or devices.

7. The detection method according to claim 1, wherein the electronic system comprises a plurality of counting hardware blocks each configured to measure one of the representative parameters, and wherein said measuring comprises measuring a plurality of representative parameters.

8. The detection method according to claim 1, further comprising:
comparison of comparing the or each inconsistency associated with the issued alert with a set of predetermined known anomalies; and
categorization of categorizing the alert when the or each inconsistency corresponds to one of the known anomalies of the set of anomalies.

9. The detection method according to claim 1, wherein the electronic system is a calculator carried on-board a transport platform.

10. The detection method claim 1, implemented by a system selected from the group consisting of:
a dedicated programmable logic circuit forming one of the hardware blocks of the processor,
a software of an operating system of the electronic system interacting with a memory protected by a memory protection unit, and
an application implemented by the electronic system by adding a driver controlling the hardware blocks.

11. A computer program product comprising a readable storage medium on which is stored a computer program comprising program instructions, wherein the computer program is loaded on a data processing unit and implements a detection method according to claim 1 when the computer program is implemented on the data processing unit.

12. A readable storage medium having stored thereon, a computer program product according to claim 11.

13. A calculator carried on-board a transport platform implementing the detection method according to claim 1, the electronic system being the on-board calculator.

14. A transport platform comprising the calculator according to claim 13.

15. The detection method according to claim 2, wherein said detecting an anomaly detects a cyberattack or a hardware failure of one of the hardware blocks.

16. The detection method according to claim 1, wherein when at least one alert associated with one of the hardware blocks is transmitted, a new iteration of the detection method is implemented starting from said measuring, wherein the set of hardware blocks for which a representative parameter measurement is performed is, at each iteration, included in the set of hardware blocks associated with the alert or alerts.

17. The detection method according to claim 1, wherein the electronic system comprises a plurality of counting hardware blocks each configured to measure one of the representative parameters, and wherein said measuring comprises measuring four representative parameters.

18. The detection method according to claim 1, wherein the electronic system comprises a plurality of counting hardware blocks each configured to measure one of the representative parameters, and wherein said measuring comprises measuring representative parameters measured by part of the counting hardware blocks.
